(19) United States
(12) Patent Application Publication
(10) Pub. No.: US 2022/0297704 A1
(43) Pub. Date: Sep. 22, 2022

(54) Detecting Vehicle Infotainment User Position

(71) Applicant: Wind River Systems, Inc., Alameda, CA (US)

(72) Inventors: Ionut POPA, Galati (RO); Costel STOICA, Galati (RO); Florin TUDORACHE, Vadeni (RO)

(21) Appl. No.: 17/249,919

(22) Filed: Mar. 18, 2021

(51) Int. Cl. B60W 50/00; B60W 40/09; G06K 9/00

(52) U.S. Cl. CPC B60W 50/0098; B60W 40/09; G06K 9/00805; B60W 2420/403; B60W 2540/227; B60W 2540/215

(57) ABSTRACT

An in-vehicle infotainment (IVI) system is described that includes a display device, an input device communicatively coupled to the display device, and one or more sensors disposed proximate to the input device, wherein the IVI system is configured to determine whether a driver or a passenger is utilizing the input device based on a detection by the one or more sensors.

### BACKGROUND INFORMATION

In the automotive industry, there has been increased focus on preventing distracted driving. For example, with respect to in-vehicle infotainment (IVI) systems, various features that would require excessive attention from the driver are disabled while the vehicle is in motion.

### SUMMARY

Some exemplary embodiments provide an in-vehicle infotainment (IVI) system. The IVI system includes a display device, an input device communicatively coupled to the display device, and one or more sensors disposed proximate to the input device, wherein the IVI system is configured to determine whether a driver or a passenger is utilizing the input device based on a detection by the one or more sensors.

Other exemplary embodiments provide a method for determining access to an in-vehicle infotainment (IVI) system. The method includes determining whether a driver or passenger of the vehicle is accessing an input device of the IVI system based on a detection by one or more sensors disposed proximate the input device, and providing a predetermined level of access to the IVI system based on the determination of whether the driver or the passenger is accessing the input device.

### BRIEF DESCRIPTION OF THE DRAWINGS

FIGS. 1A and 1B show an exemplary in-vehicle infotainment (IVI) system used to determine a user position according to the exemplary embodiments.

FIGS. 2A and 2B shows an exemplary IVI system used to determine a user position according to the exemplary embodiments.

FIG. 3 shows an exemplary method of restricting access to IVI features based on a user position according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, a system, and a method for determining the position of an operator of an in-vehicle infotainment (IVI) system and modifying the functionality of the IVI system based on that determined position of the operator.

As noted above, reducing or substantially preventing distracted driving has been a focus of IVI system manufacturers. Typically, IVI systems automatically disable specific features while the vehicle is in motion. However, this may be undesirable in circumstances where the passenger is controlling the IVI system and wishes to have access to these disabled features. In addition, some IVI systems include sensors to detect when a hand is in proximity to the IVI system so that the IVI system can display specific controls when the sensors detect the presence of a hand.

According to embodiments of the present disclosure, an IVI system includes one or more sensors disposed proximate to the IVI controls. The one or more sensors are configured to determine a direction from which a user's hand approaches the IVI controls. Based on this determination, the IVI system may determine whether the driver or passenger is utilizing the IVI system controls. This determination is then used by the IVI system to disable or allow specific functions and/or modify the user interface (UI) of the IVI display. Although the following description is made with regards to an IVI system, it should be noted that this disclosure is equally applicable to an ordinary vehicle entertainment system.

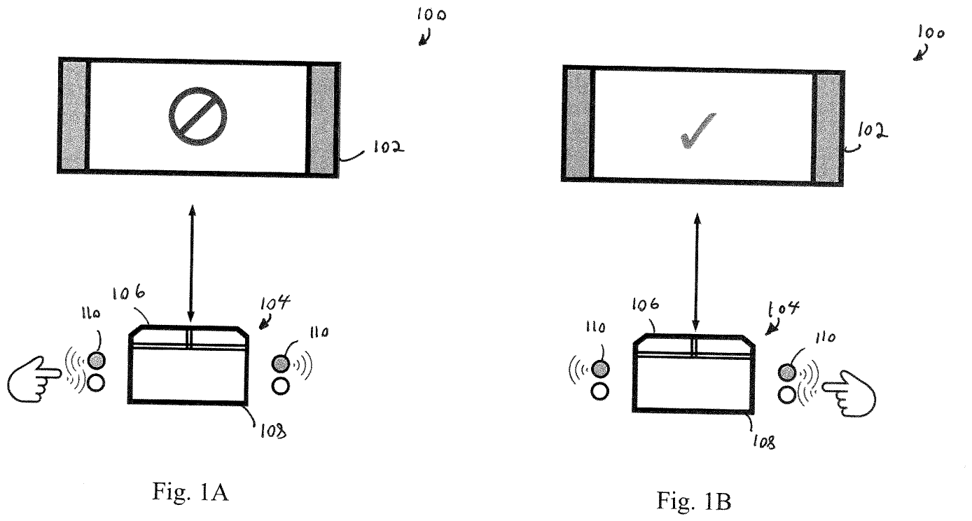

FIGS. 1A and 1B show an exemplary in-vehicle infotainment (IVI) system 100 used to determine a user position according to the exemplary embodiments. In some embodiments, the IVI system 100 includes a display 102 communicatively coupled to an input device 104. The input device 104 may be coupled to the display 102 wirelessly or via a wired connection. The input device 104 may include any combination of buttons 106 and a trackpad 108. However, it should be noted that the buttons 106 and the trackpad 108 are only provided for illustrative purposes and that the input device 104 may include any known input features configured to allow a user to select a desired feature.

As illustrated in FIGS. 1A and 1B, the IVI system 100 further includes one or more sensors 110 (two shown) disposed proximate to the IVI input device 104. In some embodiments, the sensors 110 may be proximity sensors. In such an embodiment, the sensors 110 may emit a signal (e.g., electromagnetic, light, etc.) and sense a change in the output signal when an object (e.g., a user's hand) is proximate the sensor 110. Based on this change, the IVI system can determine the direction from which a user is accessing the IVI input device 104. As shown in FIG. 1A, when the IVI system 100 determines that the driver is accessing the input device 104 based on the detection by the sensors 110, the IVI system 102 may disable one or more functionalities. Alternatively, if the IVI system 100 determines that the passenger is accessing the input device 104 as shown in FIG. 1B, the IVI system 100 does not disable any functionalities. It should be noted that the sensors 110 may be any type of sensor capable of detecting the direction from which a user accesses the IVI input device 104 such as, for example, one or more image sensors.

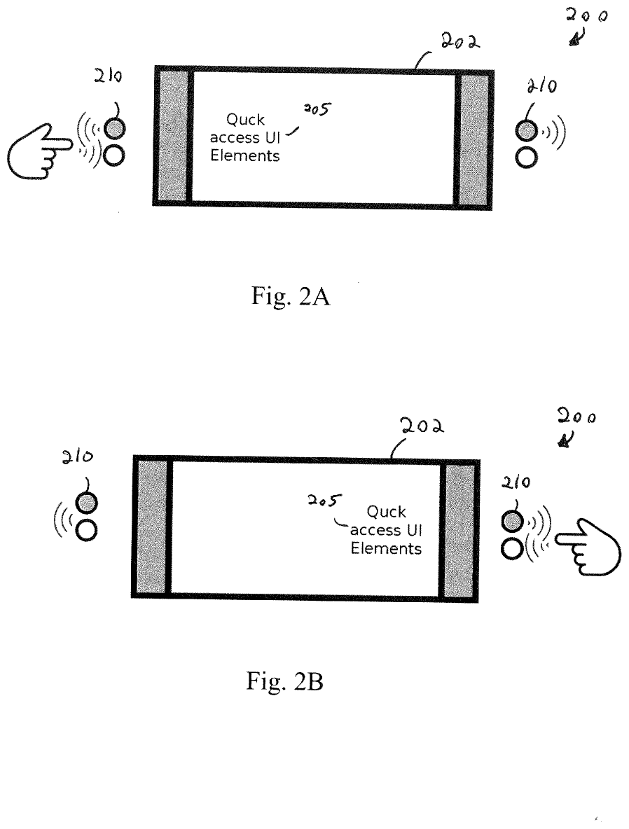

FIGS. 2A and 2B shows an exemplary IVI system 200 according to the exemplary embodiments. In some embodiments, the IVI system 200 may be a touch screen system that includes a display 202 and one or more sensors 210 disposed proximate the display 202. Since the IVI system 100 is a touch screen system, the display also functions as the input device. The sensors 210 are similar to the sensors 110 described above and are configured to determine from which direction a user is accessing the IVI system 200. Based on this determination, the IVI system 200 may disable one or more features if it determines that the driver of the vehicle is accessing the IVI system 200.

In some embodiments, the IVI system 200 may additionally change the configuration of the UI on the display screen based on the determination of whether the driver or passenger is accessing the IVI system 200. For example, as illustrated in FIG. 2A, if the IVI system 200 determines that the driver is operating the system, the system may display one or more quick access UI elements (shortcuts) 205 on the driver side of the display 202 so that these UI elements 205 are more easily accessible to the driver. Similarly, as shown in FIG. 2B, when the IVI system 200 determines that the passenger is operating the system, the system displays the quick access UI elements 205 on the passenger side of the display 202.

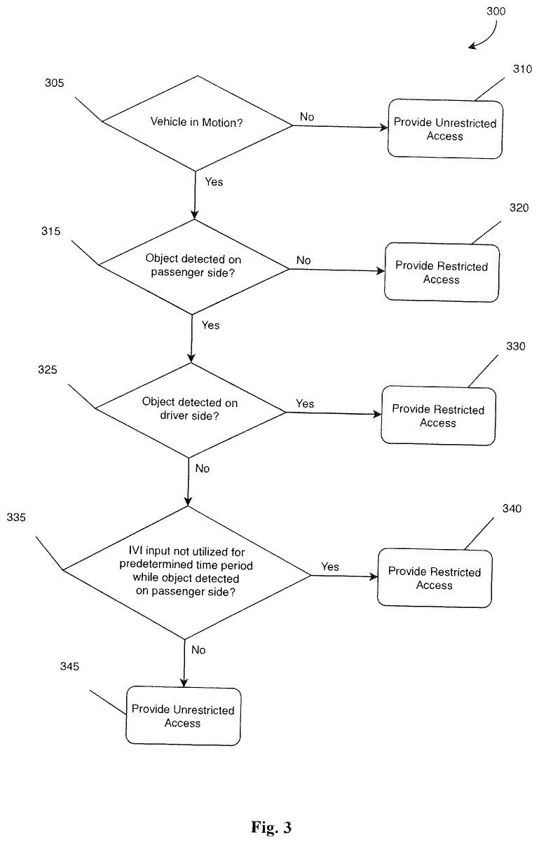

FIG. 3 shows an exemplary method 300 of restricting access to IVI features based on a user position according to the exemplary embodiments. The method 300 assumes that a sensor is disposed on the driver side and a sensor is disposed on the passenger side. However, as noted above, any number of sensors may alternatively be utilized to determine a direction from which a user's hand approaches the IVI system input.

At 305, the IVI system (100 or 200) determines whether the vehicle is in motion. If it is determined that the vehicle is not in motion, the IVI system provides unrestricted access to the system. That is, no features are disabled if the vehicle is not in motion. If, however, the IVI system determines that the vehicle is in motion, at 315, the system determines whether the passenger side sensor(s) detect an object. If the passenger side sensor(s) does not detect an object, then, at 320, the IVI system enters driver mode and restricts access to one or more features of the system. If, however, the passenger side sensor(s) does detect an object, then, at 325, the IVI system determines if the driver side sensor(s) also detects an object. If the driver side sensor detects an object (in addition to the passenger side sensor), then the IVI system enters driver mode and restricts access to one or more features of the system. Such a scenario may occur if the passenger is utilizing the controls and the driver also attempts to utilize the controls contemporaneously. Such a scenario may also occur if the user attempts to circumvent the safety features of the IVI system by permanently blocking the passenger side sensor(s) so that the system always assumes the passenger is utilizing the input device while also attempting to utilize the input device.

However, if the driver side sensor(s) does not detect an object, then, at 335, the IVI system determines whether the IVI input device has not been utilized for a predetermined period of time even though the passenger side sensor(s) detects an object. Such a scenario may be encountered if the user attempts to circumvent the safety features of the IVI system by permanently blocking the passenger side sensor(s) so that the system always assumes the passenger is utilizing the input device. In such a scenario, if the IVI system determines that the passenger side sensor is indicating the presence of an object but the input device has not been utilized for a predetermined period of time, then the IVI system will enter driver mode and restrict access to one or more features of the system. If, however, the input device has been utilized within the predetermined period of time and the passenger side sensor(s) indicates the presence of an object, then the IVI system will provide unrestricted access at 345.

Those skilled in the art will understand that the above-described exemplary embodiments may be implemented via other means or in any suitable software or hardware configuration or combination thereof. For example, although the exemplary embodiments have been described with sensors disposed on the driver and passenger sides, the IVI system may alternatively include an array of sensors disposed around the IVI input device. In addition, the IVI system (100, 200) may additionally utilize additional input from sensors (e.g., seat occupancy sensors) disposed in the vehicle to confirm whether the passenger is accessing the IVI input device. In a further example, the exemplary embodiments of the above described method may be embodied as a program containing lines of code stored on a non-transitory computer readable storage medium that may be executed on a processor or microprocessor.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. An in-vehicle infotainment (IVI) system, comprising:
a display device;
an input device communicatively coupled to the display device; and
one or more sensors disposed proximate to the input device, wherein the IVI system is configured to determine whether a driver or a passenger is utilizing the input device based on a detection by the one or more sensors.

2. The IVI system of claim 1, wherein the one or more sensors include at least one sensor on a driver side of the input device and at least one sensor on a passenger side of the input device.

3. The IVI system of claim 2, wherein, if the at least one sensor on the driver side and the at least one sensor on the passenger side detect the presence of an object proximate the input device, the IVI system is configured to restrict access to one or more features if the IVI system.

4. The IVI system of claim 1, wherein the one or more sensors are proximity sensors configured to detect the presence of a user's hand.

5. The IVI system of claim 1, wherein the input device is independent of the display device.

6. The IVI system of claim 1, wherein the input device is incorporated in the display device.

7. The IVI system of claim 1, wherein the IVI system is configured to restrict access to one or more features if the IVI system determines the driver is utilizing the input device.

8. The IVI system of claim 7, wherein the IVI system is configured to provide unrestricted access if the IVI system determines the passenger is utilizing the input device.

9. A method for determining access to an in-vehicle infotainment (IVI) system, the method comprising:
determining whether a driver or passenger of the vehicle is accessing an input device of the IVI system based on a detection by one or more sensors disposed proximate the input device; and
providing a predetermined level of access to the IVI system based on the determination of whether the driver or the passenger is accessing the input device.

10. The method of claim 9, wherein the predetermined level of access includes restricted access to one or more features of the IVI system if it is determined that the driver is accessing the input device.

11. Them method of claim 9, wherein the predetermined level of access includes unrestricted access to all features of the IVI system if it is determined that the passenger is accessing the input device.

12. The method of claim 9, wherein, if the one of more sensors indicates that the passenger is accessing the input device and the input device has not been utilized for a predetermined period of time, the predetermined level of access includes restricted access to one or more features of the IVI system.

13. The method of claim 9, wherein, if the one or more sensors indicate that both the passenger and the driver are accessing the input device, the predetermined level of access includes restricted access to one or more features of the IVI system.

14. The method of claim 9, wherein the one or more sensors are proximity sensors.

15. The method of claim 14, wherein the one or more sensors include at least one sensor disposed on a driver side of the input device and at least one sensor disposed on a passenger side of the input device.

16. The method of claim 9, wherein the IVI system includes a display device.

17. The method of claim 16, wherein the input device is independent of the display device.

18. The method of claim 16, wherein the input device is incorporated in the display device.
